(19) United States
(12) Patent Application Publication
(10) Pub. No.: US 2023/0409995 A1
(43) Pub. Date: Dec. 21, 2023

(54) PRODUCTION PLANNING OPTIMIZATION FOR AUTOMOTIVE ACCESSORY INSTALLATION

(71) Applicant: Toyota Motor North America, Inc., Plano, TX (US)

(72) Inventors: Nick S. Wu, Frisco, TX (US); Anthony D. Sanor, Melissa, TX (US)

(73) Assignees: Toyota Motor North America, Inc., Plano, TX (US); Toyota Jidosha Kabushiki Kaisha, Aichi-Ken (JP)

(21) Appl. No.: 17/842,569

(22) Filed: Jun. 16, 2022

(51) Int. Cl. G06Q 10/06

(52) U.S. Cl. CPC G06Q 10/06311; G06Q 10/06316

(57) ABSTRACT

Systems and methods for production planning optimization for automotive accessory installation are provided. A method includes generating, by a processor, a vehicle identification number (VIN) work pool including a list of available VINs based on one or more VIN lists and a list of VIN exclusions. The method further includes calculating, by the processor, a line target work pool based on available resources. The method further includes calculating, by the processor, one or more production target work pools based on the VIN work pool and the line target work pool. The method further includes selecting, by the processor, a VIN from the VIN work pool for assignment to an assembly schedule based on an age of the VIN and a degree of the VIN satisfying the line target work pool, and the one or more production target work pools. Associated systems are also provided.

### TECHNICAL FIELD

The present disclosure relates generally to vehicle assembly, and, more particularly, to systems and methods for production planning optimization for automotive accessory installation.

### BACKGROUND

Variations in vehicle configurations (i.e., vehicle variants) can create challenges for a build to stock approach. For example, some vehicle models may include hundreds, thousands, or more option variants. As a result, dealer stocks of vehicles often do not meet customer needs, leading to many customers purchasing vehicles that do not have all the desired available options. In addition, a finished vehicle can take several months to deliver to the end customers, with the largest contributor to such delay often being queuing time at a vehicle distribution center.

Therefore, a need exists in the art for systems and methods that address the above deficiencies, or at least offers an improvement, in the art. For example, a need exists for systems and methods that create a unique and optimized production planning algorithm for accessory installation on finished vehicles to reduce the queuing at vehicle distribution centers.

### BRIEF SUMMARY

Various embodiments of the present disclosure include a method for determining a schedule for finally assembling vehicles. The method includes generating, by a processor, a vehicle identification number (VIN) work pool including a list of available VINs based on one or more VIN lists and a list of VIN exclusions. The method further includes calculating, by the processor, a line target work pool based on available resources. The method further includes calculating, by the processor, one or more production target work pools based on the VIN work pool and the line target work pool. The method further includes selecting, by the processor, a VIN from the VIN work pool for assignment to an assembly schedule based on an age of the VIN and a degree of the VIN satisfying the line target work pool, and the one or more production target work pools.

Various embodiments of the present disclosure include a system for implementing a scheduling process for finally assembly of vehicles. The system includes a processor configured to perform operations, including generating a VIN work pool including a list of available VINs based on one or more VIN lists and a list of VIN exclusions. The operations further include calculating a line target work pool based on available resources. The operations further include calculating one or more production target work pools based on the VIN work pool and the line target work pool. The operations further include selecting a VIN from the VIN work pool for assignment to an assembly schedule based on an age of the VIN and a degree of the VIN satisfying the line target work pool, and the one or more production target work pools.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 is a diagram of a scheduling process for final assembly of vehicles, according to one or more embodiments of the disclosure.

FIG. 2 is a diagram of a process of generating a VIN work pool, according to one or more embodiments of the disclosure.

FIG. 3 is a diagram of a process of calculating a line target work pool, according to one or more embodiments of the disclosure.

FIG. 4 is a diagram of a process of calculating regional production targets, according to one or more embodiments of the disclosure.

FIG. 5 is a diagram of a process of calculating dealer production targets, according to one or more embodiments of the disclosure.

FIG. 6 is a diagram of a process of calculating vehicle model and/or trim production targets, according to one or more embodiments of the disclosure.

FIG. 7 is a diagram of a process of calculating install time production targets, according to one or more embodiments of the disclosure.

FIG. 8 is a diagram of a process of selecting a VIN for assignment to an assembly schedule, according to one or more embodiments of the disclosure.

FIG. 9 is a flowchart of a method of determining a schedule for final assembly of vehicles, according to one or more embodiments of the disclosure.

FIG. 10 is a diagram illustrating an example computing or processing system, according to one or more embodiments of the disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

Embodiments of the present disclosure are directed to production planning optimization for automotive accessory installation that makes a significant improvement on existing technology by incorporating the elements of Heijunka-based production scheduling. Heijunka may be defined as “distributing the production of different body types evenly over the course of a day, a week, and a month in the assembly process.” To achieve this goal, the production process ensures an efficient production mix that mirrors market demand along with leveling and balance of production lines. Focusing on these elements can create a stable production environment that is designed to meet customer demand.

Embodiments of the present disclosure are directed to leveraging one or more production principles (e.g., Heijunka principle, FIFO, fullwork time, etc.) to optimize allocation of vehicles for post-production and delivery. The allocations may be made on a daily or weekly forecasting basis, or any interval of time between deliveries from the factory, such as the arrival of the next ocean vessel. In embodiments, VINs on board a vessel may be included in the allocation process, but ground-aged units may be intended to have priority. Thus, embodiments of the present disclosure may improve production planning, match customer demand with total output, reduce the age of ground units, balance assembly lines and meet line capacities, thereby further reducing resource scheduling variations.

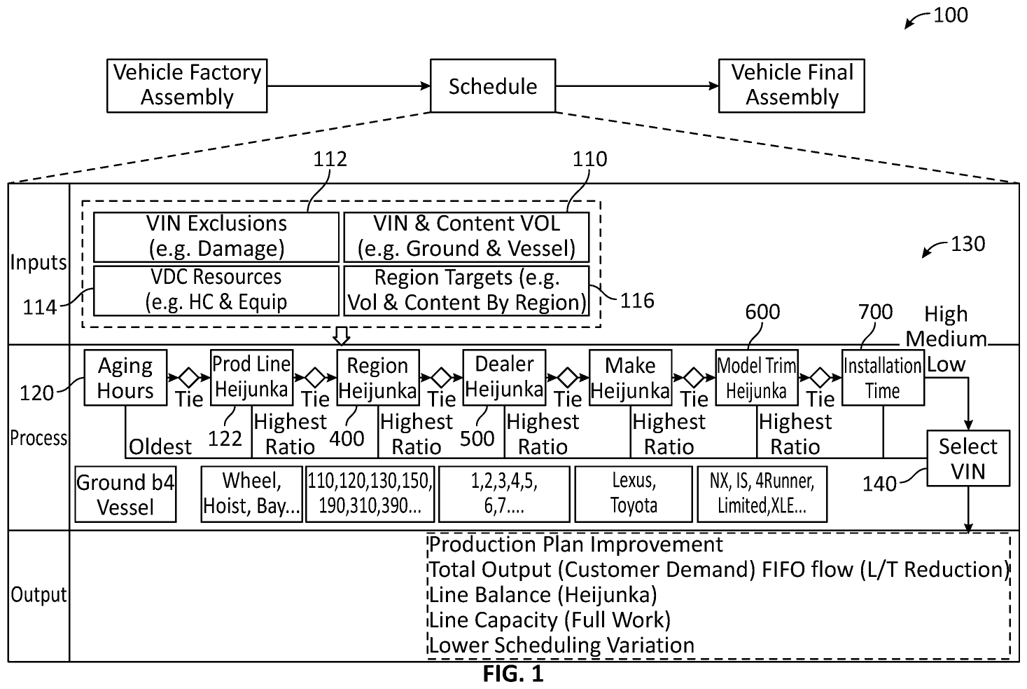

FIG. 1 is a diagram of an example scheduling process 100 for final assembly of vehicles, according to one or more embodiments of the disclosure. During final assembly of vehicles, accessories may be installed, and final quality checks may be completed. In embodiments, a factory may produce vehicles with a set of accessories, for example, consistent with a trim level, but additional accessories may be installed during final assembly at a dealer and/or at locations in transit to the dealer. For instance, factory assembly may occur in one location and then factory assembled vehicles may be shipped to a second location for accessorizing and final inspection. Vehicles at the second location (e.g., a holding lot after arriving via ship from an overseas factory) may await assignment (e.g., by vehicle identification number (VIN)) for post-production activities. In such embodiments, scheduling process 100 may reduce the time that a vehicle spends at the second location.

Referring to FIG. 1, scheduling process 100 may receive one or more inputs. As shown, inputs may include one or more VIN lists for ground and vessel bound vehicles (i.e., VIN and Content VOL 110), a list of VIN exclusions (i.e., VIN exclusion list 112), vehicle processing and distribution center (VDC) resources 114, and region targets 116. VIN exclusion list 112 may include a list of damaged VINs to exclude from post-production activities. VDC resources 114 may include head count and equipment resources. Region targets 116 may include volume and content targets by region. In embodiments, region targets 116 may include specific dealer targets and trim targets.

Using inputs, scheduling process 100 may generate several specific work pools, work pool targets, and/or target databases. For example, scheduling process 100 may generate a VIN work pool 120, a line target work pool 122, and one or more production target work pools 130 based on VIN work pool 120 and line target work pool 122, as detailed below. For example, production line targets, install time targets, dealer and/or region targets, and model and/or trim targets may be generated, among others. Generation of each of the specific work pools and targets may include specific processes, such as sorting, grouping, and ratio calculating based on completed production.

Once the work pools/targets are defined for a scheduling period, such as a day or a week, a VIN selection process 140 may be executed. As detailed below, VIN selection process 140 may include a stepwise approach to selecting vehicles from the work pool for assignment to an assembly schedule. For example, VIN selection process 140 may select vehicles from the VIN lists for ground, first, and vessel-bound vehicles, second, and assigning the VINs to final assembly resources/activities within the scheduling period based on a narrow-to-broad determination process having sets of matching criteria that are biased to assigning VINs with the oldest age and match the highest ratios defined by the specific targets. As a VIN is assigned to the schedule, the VIN is removed from the VIN list and the work pool/targets are updated such that target ratios may be updated. In this manner, a balanced assignment of vehicles may be achieved. Such a production plan improvement may provide line balance, improve line capacity, lower scheduling variation, increase total output, meet customer demand(s), and/or improve first in first out (FIFO) flow, among other benefits.

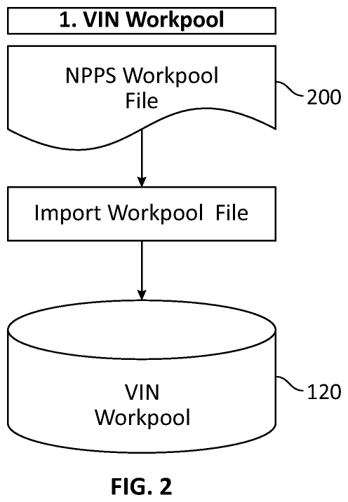

FIG. 2 is a diagram of a process of generating VIN work pool 120, according to one or more embodiments of the disclosure. Referring to FIG. 2, VIN work pool 120 may include a list of available VINs based on one or more VIN lists (e.g., VIN & Content VOL 110) and VIN exclusion list 112. As shown, VIN work pool 120 may be generated by importing a work pool file 200 (e.g., an NPPS work pool file), which may contain the one or more VIN lists and VIN exclusion list 112. In embodiments, VIN work pool 120 may sort the list of available VINs by age, such that the oldest VINs are prioritized.

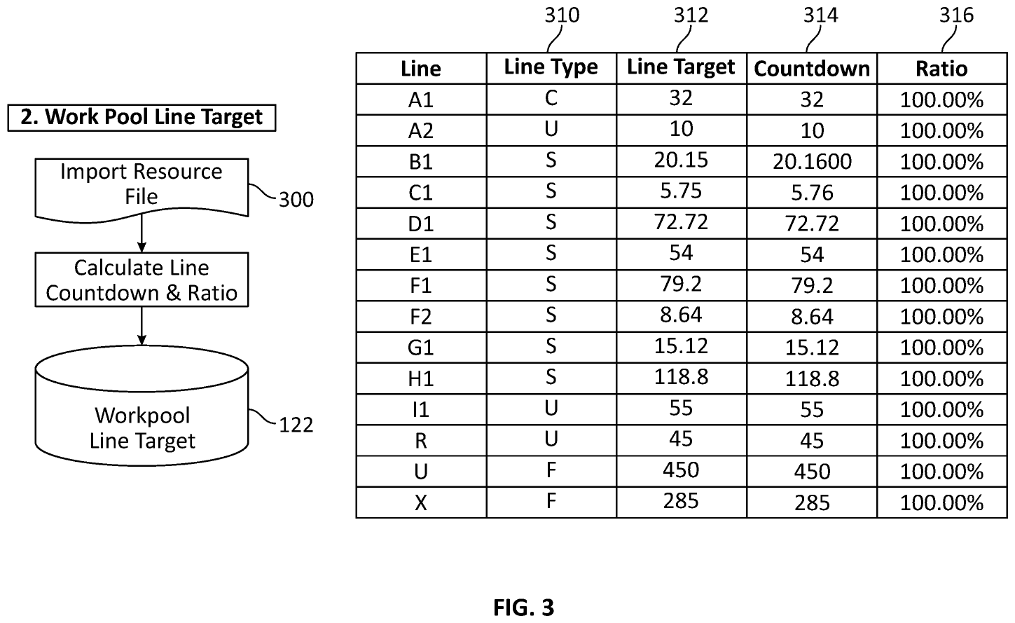

FIG. 3 is a diagram of a process of calculating the line target work pool 122, according to one or more embodiments of the disclosure. Referring to FIG. 3, line target work pool 122 may be calculated based on available resources (e.g., VDC resources 114). For example, line target work pool 122 may be generated by importing a resource file 300, which may contain VDC resources 114. As shown, line target work pool 122 may include a list of assembly lines each defined by a line type 310 and a line target 312. A countdown value for each assembly line (e.g., line countdown 314) may be initially set at the line target and continuously or near-continuously updated during assembly line production (e.g., reduced as corresponding vehicles are finally assembled at each assembly line). A line ratio 316 may be determined for each assembly line, with the line ratio 316 determined by dividing the line countdown 314 by the line target 312. The line ratio 316 may be continuously or near-continuously updated as vehicles are assigned and/or finally assembled at each assembly line. Depending on the application, the list of assembly lines may be sorted by line ratio 316 (e.g., in descending order), such that VINs may be assigned to assembly lines with the highest ratios. In this manner, a balanced assignment of VINs to assembly lines may be achieved.

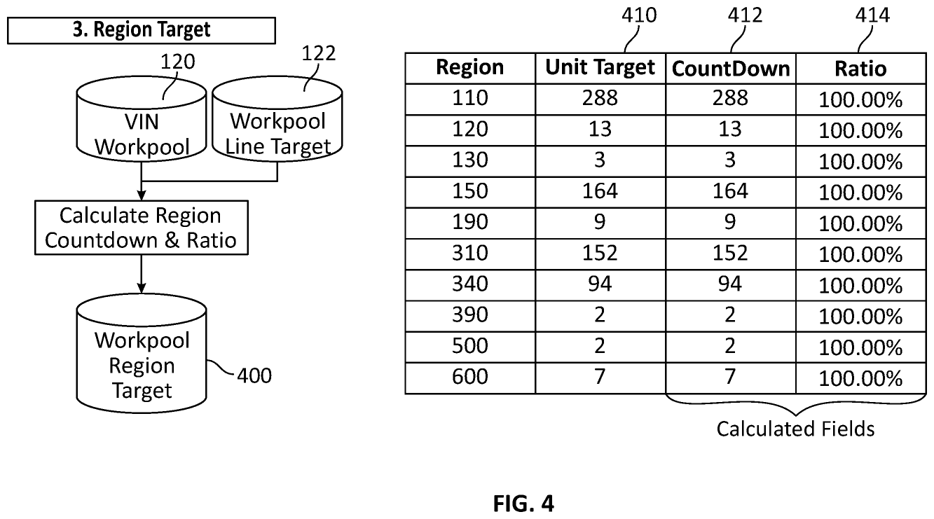

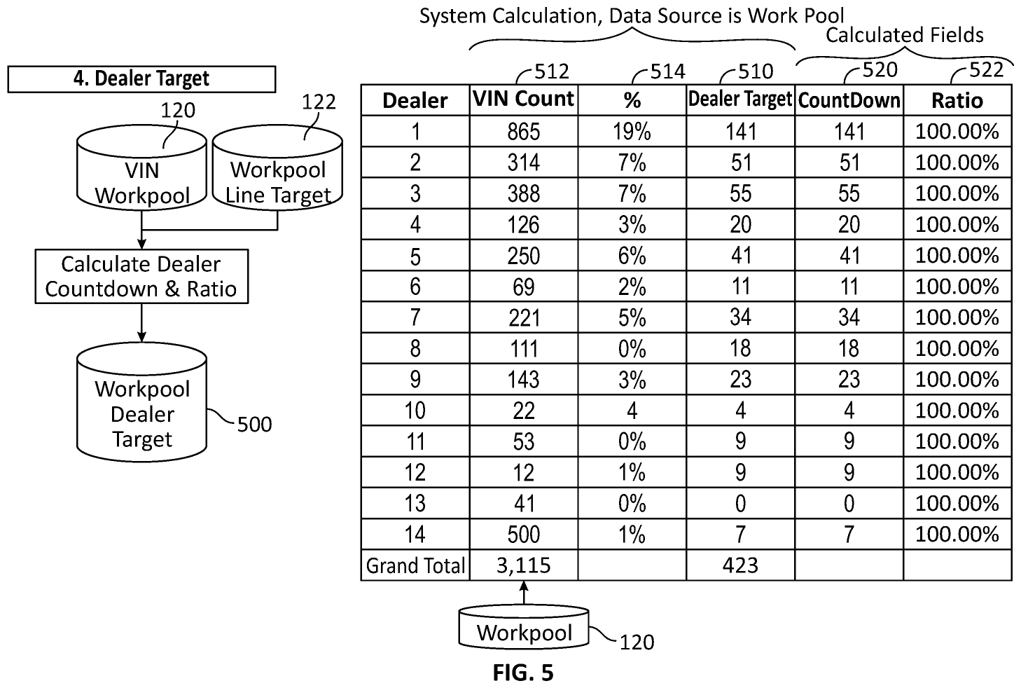

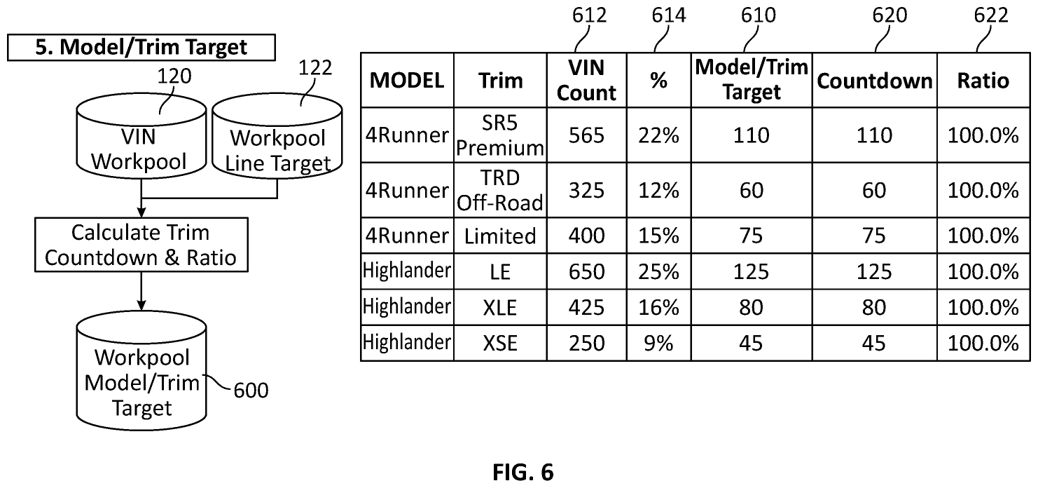

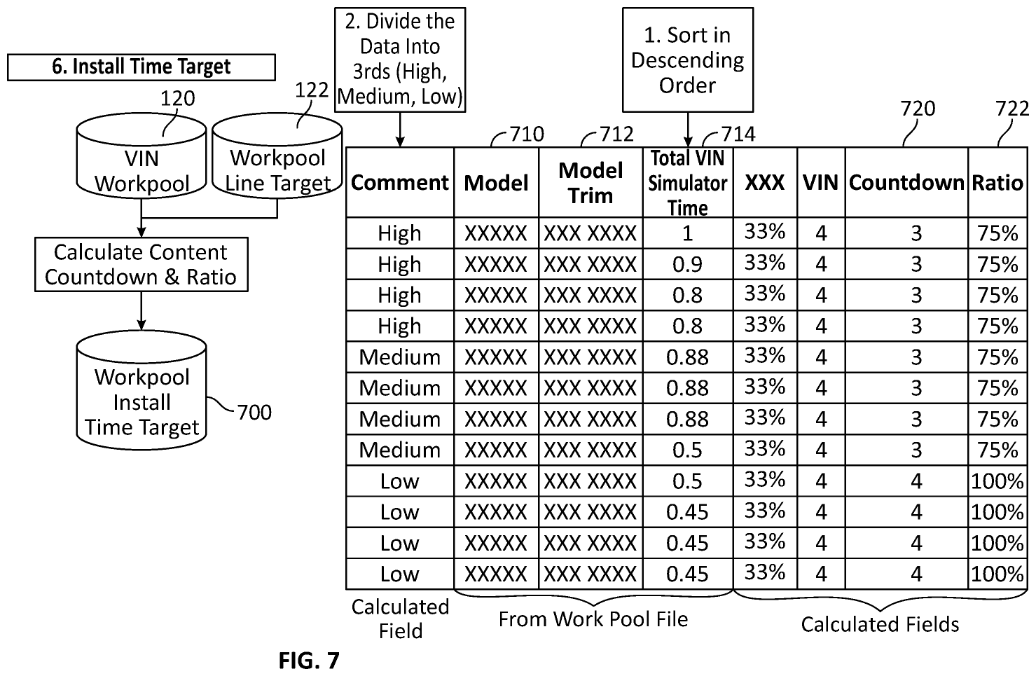

FIGS. 4-7 illustrates various processes of calculating the one or more production targets based on work pool and line target work pool 122. Referring to FIGS. 4-7, the one or more production targets may include a plurality of production targets. Specifically, FIG. 4 is a diagram of a process calculating regional production targets, according to one or more embodiments of the disclosure. FIG. 5 is a diagram of a process of calculating dealer production targets, according to one or more embodiments of the disclosure. FIG. 6 is a diagram of a process of calculating vehicle model and/or trim production targets, according to one or more embodiments of the disclosure. FIG. 7 is a diagram of a process of calculating install time production targets, according to one or more embodiments of the disclosure. Similar to calculation of line target work pool 122, the production targets may be calculated based on a Heijunka production principle. For example, the production targets may be calculated with a focus on balancing the distribution of vehicles (e.g., models, trims, etc.) to regions and dealers (e.g., based on respective share of market, based on assembly capacity, etc.).

Referring to FIG. 4, a region target work pool 400 may be calculated based on VIN work pool 120 and line target work pool 122. Region target work pool 400 may include a list of regions each defined by a unit target 410. A countdown value for each region (e.g., a region countdown 412) may be initially set at the unit target 410 and continuously or near-continuously updated during vehicle allocation/production (e.g., reduced as corresponding vehicles are assigned to each region). A region ratio 414 may be determined for each region, with the region ratio 414 determined by dividing the region countdown 412 by the unit target 410. The region ratio 414 may be continuously or near-continuously updated as vehicles are assigned and/or finally assembled. In embodiments, the list of regions may be sorted by region ratio 414 (e.g., in descending order), such that VINs may be assigned to regions with the highest ratios, thereby allowing a balanced assignment of VINs to the respective regions.

Referring to FIG. 5, a dealer target work pool 500 may be calculated based on VIN work pool 120 and line target work pool 122. Dealer target work pool 500 may include a list of dealers each defined by a dealer target 510. In embodiments, the list of dealers may be defined by a VIN count 512 (e.g., the number of vehicles at each dealer) and a market share percentage 514 (e.g., the dealer's allocation percentage of total vehicles based on VIN count 512). Dealer target 510 may be set based on market share percentage 514. For instance, dealer target 510 may be calculated as the dealer's market share percentage 514 of an associated assembly line target. A countdown value for each dealer (e.g., a dealer countdown 520) may be initially set at the dealer target 510 and continuously or near-continuously updated during vehicle allocation/production (e.g., reduced as corresponding vehicles are assigned to each dealer). A dealer ratio 522 may be determined for each dealer, with the dealer ratio 522 determined by dividing the dealer countdown 520 by the dealer target 510. The dealer ratio 522 may be continuously or near-continuously updated as vehicles are assigned and/or finally assembled. In embodiments, the list of dealers may be sorted by dealer ratio 522 (e.g., in descending order), such that VINs may be assigned to dealers with the highest ratios, thereby allowing a balanced assignment of VINs to the respective dealers.

Referring to FIG. 6, a model/trim target work pool 600 may be calculated based on VIN work pool 120 and line target work pool 122. Model/trim target work pool 600 may include a list of vehicle models and trims each defined by a model/trim target 610. In embodiments, the list of vehicle models and trims may be defined by a VIN count 612 (e.g., the number of each vehicle model/trim configuration across dealers and regions) and a market share percentage 614 (e.g., the model/trim allocation percentage of total vehicles based on VIN count). Model/trim target 610 may be set based on market share percentage 614. For instance, model/trim target 610 may be calculated as the model/trim's market share percentage 614 of an associated assembly line target. A countdown value for each vehicle model/trim (e.g., a model/trim countdown 620) may be initially set at the model/trim target 610 and continuously or near-continuously updated during vehicle allocation/production (e.g., reduced as corresponding vehicles are assigned for final assembly). A model/trim ratio 622 may be determined for each vehicle model/trim, with the model/trim ratio 622 determined by dividing the model/trim countdown 620 by the model/trim target 610. The model/trim ratio 622 may be continuously or near-continuously updated as vehicles are assigned and/or finally assembled. In embodiments, the list of vehicle models and trims may be sorted by model/trim ratio 622 (e.g., in descending order), for similar reasons as noted above.

Referring to FIG. 7, an install time target work pool 700 may be calculated based on VIN work pool 120 and line target work pool 122. Install time target work pool 700 may include a list defined by vehicle model 710, model trim 712, and an accessory install time 714 for each model/model trim. The accessory install time 714 may be based on simulations (e.g., a total VIN simulator time) and benchmarked to a standard (e.g., a longest simulated install time). The list may be sorted in descending order based on accessory install time 714. In embodiments, the list may be divided into thirds (e.g., high, medium, low), such as to provide a layer of prioritization based on accessory install time 714. As shown, a countdown value (e.g., an install time countdown 720) and an install time ratio 722 may be determined for each model.

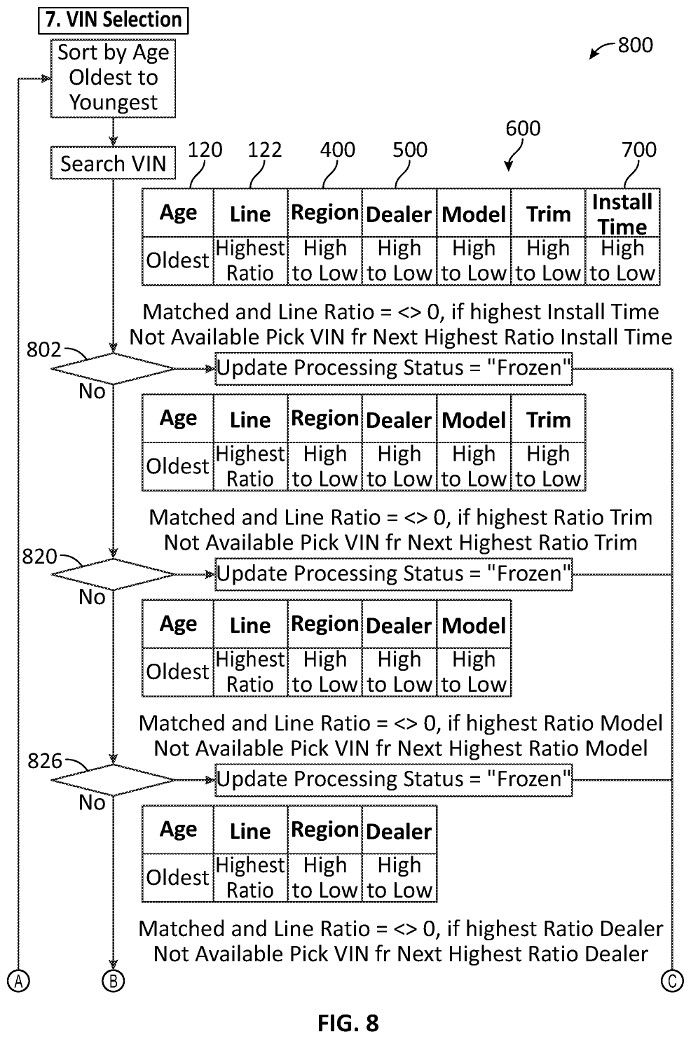

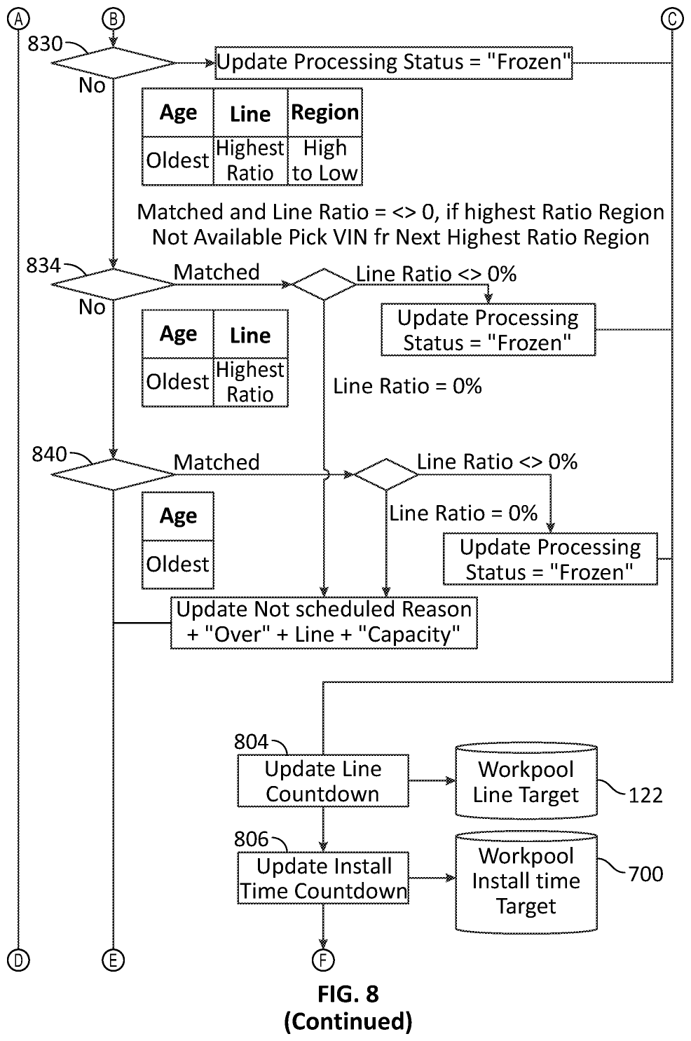

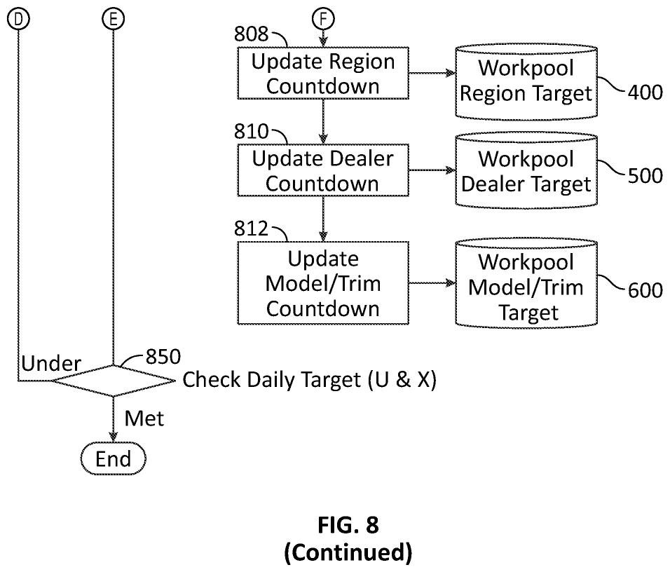

FIG. 8 is a diagram of a process 800 of selecting a VIN for assignment to an assembly schedule (e.g., VIN selection process 140), according to one or more embodiments of the disclosure. For explanatory purposes, process 800 is described with reference to FIGS. 1-7. Note that one or more operations in FIG. 8 may be combined, omitted, and/or performed in a different order as desired. According to various embodiments, process 800 may be performed by a logic device or a combination of logic devices, which may be communicatively coupled to execute the operations of process 800.

Referring to FIG. 8, a VIN may be selected from VIN work pool 120 for assignment to an assembly schedule based on an age of the VIN and a degree of the VIN satisfying line target work pool 122 and the one or more production targets. For example, a stepwise approach may be applied to determine the VIN with the oldest age that satisfies the line target work pool 122 and the production targets (e.g., the greatest number of line target work pool 122 and the production targets).

In block 802, process 800 includes matching a VIN with the oldest age in VIN work pool 120 that satisfies line target work pool 122, region target work pool 400, dealer target work pool 500, model/trim target work pool 600, and install time target work pool 700. If the highest install time is not available for the oldest VIN, the VIN from the next highest ratio install time may be selected.

If a VIN is matched in block 802, the various targets/work pools may be updated. For example, the matched VIN may be removed from VIN work pool 120 and process 800 may proceed to blocks 804, 806, 808, 810, and 812. In block 804, the line countdown 314 may be updated to update line target work pool 122. In block 806, the install time countdown 720 may be updated to update install time target work pool 700. In block 808, the region countdown 412 may be updated to update region target work pool 400. In block 810, the dealer countdown 520 may be updated to update dealer target work pool 500. In block 812, the model/trim countdown 620 may be updated to update model/trim target work pool 600.

If a VIN is not matched in block 802, in block 820, process 800 includes matching a VIN with the oldest age in VIN work pool 120 that satisfies line target work pool 122, region target work pool 400, dealer target work pool 500, and model/trim target work pool 600 (e.g., a model target work pool and a trim target work pool). If the highest ratio trim is not available for the oldest VIN, the VIN from the next highest ratio trim may be selected. If a VIN is matched in block 820, process 800 may proceed to blocks 804, 806, 808, 810, and 812, as described above.

If a VIN is not matched in block 820, in block 826, process 800 includes matching a VIN with the oldest age in VIN work pool 120 that satisfies line target work pool 122, region target work pool 400, dealer target work pool 500, and model target work pool. If the highest ratio model is not available for the oldest VIN, the VIN from the next highest ratio model may be selected. If a VIN is matched in block 826, process 800 may proceed to blocks 804, 806, 808, 810, and 812, as described above.

If a VIN is not matched in block 826, in block 830, process 800 includes matching a VIN with the oldest age in VIN work pool 120 that satisfies line target work pool 122, region target work pool 400, and dealer target work pool 500. If the highest ratio dealer is not available for the oldest VIN, the VIN from the next highest ratio dealer may be selected. If a VIN is matched in block 830, process 800 may proceed to blocks 804, 806, 808, 810, and 812, as described above.

If a VIN is not matched in block 830, in block 834, process 800 includes matching a VIN with the oldest age in VIN work pool 120 that satisfies line target work pool 122, and region target work pool 400. If the highest ratio region is not available for the oldest VIN, the VIN from the next highest ratio region may be selected. If a VIN is matched in block 834, process 800 may proceed to blocks 804, 806, 808, 810, and 812, as described above.

If a VIN is not matched in block 834, in block 840, process 800 includes matching a VIN with the oldest age in VIN work pool 120 that satisfies line target work pool 122. If a VIN is matched in block 840, process 800 may proceed to blocks 804, 806, 808, 810, and 812, as described above.

If a VIN is not matched in block 840, process 800 includes matching a VIN with the oldest age in VIN work pool 120, after which process 800 may proceed to blocks 804, 806, 808, 810, and 812, as described above.

In block 850, process 800 includes checking a production target, such as a daily or weekly production target. If the production target has not been met, process 800 may repeat until the production target is met. For example, process 800 may include iteratively selecting one or more additional VINs from VIN work pool 120 until the production target is met. If the production target is determined to be met in block 850, process 800 may end.

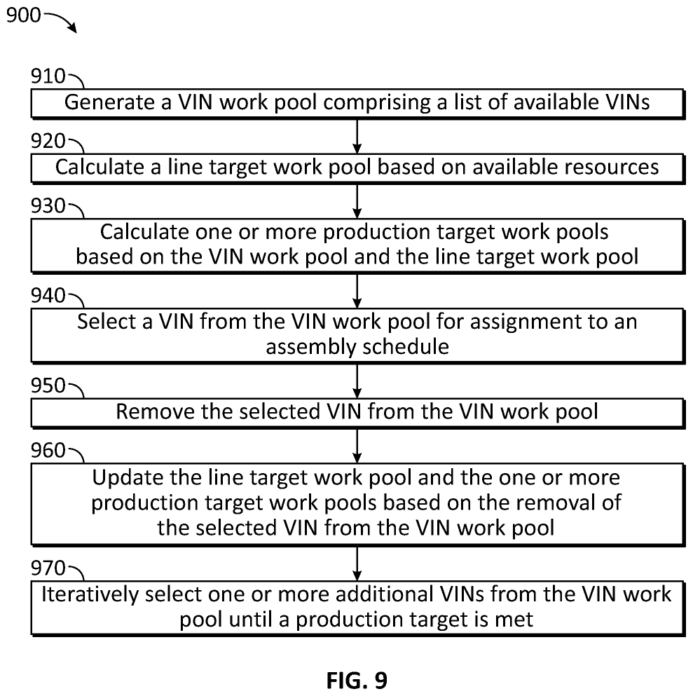

FIG. 9 is a flowchart of a method 900 of determining a schedule for final assembly of vehicles, according to one or more embodiments of the disclosure. For explanatory purposes, method 900 is described herein with reference to FIGS. 1-8, although method 900 is not limited to the embodiments illustrated in FIGS. 1-8. Note that one or more operations in FIG. 9 may be combined, omitted, and/or performed in a different order as desired. According to various embodiments, method 900 may be performed by a logic device or a combination of logic devices, which may be communicatively coupled to execute the operations of method 900.

In block 910, method 900 includes generating VIN work pool 120, including a list of available VINs based on one or more VIN lists (e.g., VIN & Content VOL 110) and a list of VIN exclusions (e.g., VIN exclusion list 112). For example, VIN work pool 120 may be generated based on a list of ground-aged vehicles and a list of vessel-bound vehicles. As detailed above, priority may be given to the list of ground-aged vehicles in selecting a VIN for assignment to the assembly schedule. Additionally, or alternatively, the list of available VINs may be sorted by age, such that the oldest VINs are prioritized. Depending on the application, VIN work pool 120 may be generated as shown in FIG. 2.

In block 920, method 900 includes calculating line target work pool 122 based on available resources, such as VDC resources 114 and/or other resources. A resource file may be imported, and based on the imported resource file, line target work pool 122 may be calculated, including line countdown 314 and line ratio 316, as detailed above with reference to FIG. 3, although other configurations are contemplated.

In block 930, method 900 includes calculating one or more (e.g., a plurality of) production target work pools 130 based on VIN work pool 120 and line target work pool 122. For example, the various countdown and ratio values may be calculated for region target work pool 400, dealer target work pool 500, model/trim target work pool 600, and install time target work pool 700, as detailed above with reference to FIGS. 4-7, although other configurations are contemplated.

In block 940, method 900 includes selecting a VIN from VIN work pool 120 for assignment to an assembly schedule. For example, block 940 may include one or more operations or processes described above with reference to FIG. 8, although other configurations are contemplated. For example, a VIN may be selected from the VIN work pool 120 based on an age of the VIN and a degree of the VIN satisfying the line target work pool 122 and the one or more production target work pools 130 (e.g., the region target work pool 400, dealer target work pool 500, model/trim target work pool 600, and install time target work pool 700, or any combination thereof). As detailed above, a stepwise approach may be applied to determine the VIN with the oldest age that satisfies the greatest number of the line target work pool 122, region target work pool 400, dealer target work pool 500, model/trim target work pool 600, and install time target work pool 700.

In block 950, method 900 includes removing the selected VIN from the VIN work pool 120 based on the VIN being selected for post-production activities. Relatedly, in block 960, method 900 includes updating the line target work pool 122, region target work pool 400, dealer target work pool 500, model/trim target work pool 600, and/or install time target work pool 700 based on the removal of the selected VIN from the VIN work pool 120.

In block 970, method 900 includes iteratively selecting one or more additional VINs from the VIN work pool 120 until a production target is met. For example, VINs may be continuously or near-continuously selected from VIN work pool 120 until a daily, weekly, or other production target is satisfied. If the production target is met, method 900 may terminate or be suspended until the next scheduling or production period begins, whereupon the method 900 may be repeated.

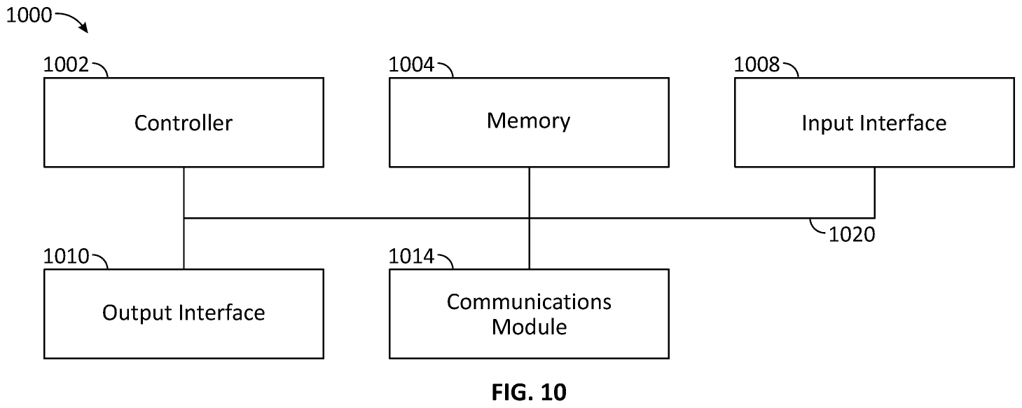

FIG. 10 is a diagram illustrating an example computing or processing system 1000 in which embodiments of the present disclosure may be implemented, according to one or more embodiments of the disclosure. For example, scheduling process 100, process 800, and/or method 900, described above, may be implemented using system 1000. System 1000 can be or include a computer, phone, PDA, tablet, server, controller, or any other type of electronic device. Such an electronic device includes various types of computer readable media and interfaces for various other types of computer readable media. As shown in FIG. 10, system 1000 includes a controller 1002, a memory 1004, an input interface 1008, an output interface 1010, and a communications module 1014.

Controller 1002, according to various embodiments, includes one or more of a processor, a microprocessor, a central processing unit (CPU), an electronic control unit, a graphics processing unit (GPU), a single-core processor, a multi-core processor, a microcontroller, a programmable logic device (PLD) (e.g., field programmable gate array (FPGA)), an application specific integrated circuit (ASIC), a digital signal processing (DSP) device, or other logic device that may be configured, by hardwiring, executing software instructions, or a combination of both, to perform various operations discussed herein for embodiments of the disclosure. Controller 1002 may be configured to interface and communicate with the various other components of system 1000 to perform such operations. For example, controller 1002 may be configured to receive and process data, store the data in memory 1004, and/or retrieve stored data from memory 1004.

Controller 1002 may include combinations of hardware and software processing functionality and may be provided with/in and/or communicatively attached to other components to execute appropriate instructions, such as software instructions and/or processing parameters stored in memory 1004. In various embodiments, controller 1002 may be configured to execute software instructions stored in memory 1004 to perform various methods, processes, or operations in the manner described herein.

Memory 1004 includes, in one embodiment, one or more memory devices configured to store data and information, including magnetic flux data and position information. The memory 1004 may include one or more various types of memory devices including volatile and non-volatile memory devices, such as random-access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drive, and/or other types of memory. As discussed above, controller 1002 may be configured to execute software instructions stored in memory 1004 to perform process and/or method (e.g., process steps and/or operations of process and/or method). Controller 1002 may be configured to store data in memory 1004.

Input interface 1008 includes, in one embodiment, a user input and/or an interface device, such as one or more controls, knobs, buttons, slide bars, keyboards, sensors, cameras, and/or other devices, that are adapted to generate an input control signal. Controller 1002 may be configured to sense the input control signals from input interface 1008 and respond to any sensed input control signals received therefrom. Controller 1002 may be configured to interpret such an input control signal as a value, as generally understood by one skilled in the art. In one embodiment, input interface 1008 may include a control unit (e.g., a wired or wireless handheld control unit) having push buttons adapted to interface with a user and receive user input control values. In one implementation, the push buttons of the control unit may be used to control various system functions.

Output interface 1010 may enable, for example, the output of data or other information. Output interface 1010 may include, for example, one or more display devices, such as monitors or other visual displays (e.g., light emitting diode (LED) displays, liquid crystal displays (LCDs), head-up displays (HUDs), or other types of displays). Some implementations include devices such as a touchscreen that function as both input and output components. Controller 1002 may be configured to render data and information on output interface 1010. For example, controller 1002 may be configured to render data on output interface 1010, such as data stored in memory 1004.

In some embodiments, various components of system 1000 may be distributed and in communication with one another over a network. In this regard, communications module 1014 may be configured to facilitate wired and/or wireless communication among various system components over the network. Such a network may include, for example, a Bluetooth low energy network, a local area network (“LAN”), such as an Intranet, or a wide area network (“WAN”), such as the Internet.

In embodiments, various components of system 1000 may be communicatively connected via a system communications bus 1020. Bus 1020 collectively represents all system, peripheral, and chipset buses that communicatively connect the numerous devices of system 1000. For instance, bus 1020 may communicatively connect controller 1002, memory 1004, input interface 1008, output interface 1010, communications module 1014, start/stop system 112, lock/unlock system 116, and authentication system 140, or any combination thereof, together.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

While certain exemplary embodiments of the invention have been described and shown in the accompanying drawings, it is to be understood that such embodiments are merely illustrative of and not restrictive on the broad invention, and that the embodiments of the invention not be limited to the specific constructions and arrangements shown and described, since various other modifications may occur to those ordinarily skilled in the art. The intention is to cover all modifications, equivalents and alternatives falling within the spirit and scope of the disclosure as defined by the claims.

For example, the elements and teachings of the various embodiments may be combined in whole or in part in some or all of the embodiments. In addition, one or more of the elements and teachings of the various embodiments may be omitted, at least in part, and/or combined, at least in part, with one or more of the other elements and teachings of the various embodiments. In addition, while different steps, processes, and procedures are described as appearing as distinct acts, one or more of the steps, one or more of the processes, and/or one or more of the procedures may also be performed in different orders, simultaneously, and/or sequentially. In some embodiments, the steps, processes, and/or procedures may be merged into one or more steps, processes, and/or procedures. In some embodiments, one or more of the operational steps in each embodiment may be omitted.

What is claimed is:

1. A method of determining a schedule for final assembly of vehicles, the method comprising:
generating, by a processor, a vehicle identification number (VIN) work pool comprising a list of available VINs based on one or more VIN lists and a list of VIN exclusions;
calculating, by the processor, a line target work pool based on available resources;
calculating, by the processor, one or more production target work pools based on the VIN work pool and the line target work pool; and
selecting, by the processor, a VIN from the VIN work pool for assignment to an assembly schedule based on an age of the VIN and a degree of the VIN satisfying the line target work pool and the one or more production target work pools.

2. The method of claim 1, wherein the selecting comprises applying a stepwise approach to determine the VIN with the oldest age that satisfies the line target work pool and the one or more production target work pools.

3. The method of claim 2, wherein the stepwise approach is based on a narrow-to-broad criteria determination.

4. The method of claim 1, wherein:
the one or more production target work pools comprises a plurality of production target work pools; and
the selecting comprises applying a stepwise approach to determine the VIN with the oldest age that satisfies a greatest number of the line target work pool and the plurality of production target work pools.

5. The method of claim 4, wherein the line target work pool and the plurality of production target work pools are calculated based on a Heijunka production principle.

6. The method of claim 1, wherein the selecting further comprises:
removing the selected VIN from the VIN work pool; and
updating the line target work pool and the one or more production target work pools based on the removal of the selected VIN from the VIN work pool.

7. The method of claim 1, wherein the calculating the one or more production target work pools comprises calculating, by the processor, at least one of:
an install time target work pool;
a region target work pool;
a dealer target work pool; or
a vehicle model/trim target work pool.

8. The method of claim 1, further comprising iteratively selecting, by the processor, one or more additional VINs from the VIN work pool until a production target is met.

9. The method of claim 1, wherein the line target work pool and the one or more production target work pools are defined for a scheduling period.

10. The method of claim 1, wherein:
the one or more VIN lists comprise a list of ground-aged vehicles and a list of vessel-bound vehicles; and
a priority is given to the list of ground-aged vehicles in selecting the VIN for assignment to the assembly schedule.

11. A system for implementing a scheduling process for final assembly of vehicles, the system comprising:
a processor configured to perform operations comprising:
generate a vehicle identification number (VIN) work pool comprising a list of available VINs based on one or more VIN lists and a list of VIN exclusions,
calculate a line target work pool based on available resources,
calculate one or more production target work pools based on the VIN work pool and the line target work pool, and
select a VIN from the VIN work pool for assignment to an assembly schedule based on an age of the VIN and a degree of the VIN satisfying the line target work pool and the one or more production target work pools.

12. The system of claim 11, wherein the processor is configured to apply a stepwise approach to determine the VIN with the oldest age that satisfies the line target work pool and the one or more production target work pools.

13. The system of claim 12, wherein the stepwise approach is based on a narrow-to-broad criteria determination.

14. The system of claim 11, wherein:
the one or more production target work pools comprises a plurality of production target work pools; and
the processor is configured to apply a stepwise approach to determine the VIN with the oldest age that satisfies a greatest number of the line target work pool and the plurality of production target work pools.

15. The system of claim 14, wherein the line target work pool and the plurality of production target work pools are calculated based on a Heijunka production principle.

16. The system of claim 11, wherein the processor is configured to:
remove the selected VIN from the VIN work pool; and
update the line target work pool and the one or more production target work pools based on the removal of the selected VIN from the VIN work pool.

17. The system of claim 11, wherein the one or more production target work pools comprises at least one of:
an install time target work pool;
a region target work pool;
a dealer target work pool; or
a vehicle model/trim target work pool.

18. The system of claim 11, wherein the processor is configured to iteratively select one or more additional VINs from the VIN work pool until a production target is met.

19. The system of claim 11, wherein the line target work pool and the one or more production target work pools are defined for a scheduling period.

20. The system of claim 11, wherein:
the one or more VIN lists comprise a list of ground aged vehicles and a list of vessel-bound vehicles; and
a priority is given to the list of ground aged vehicles in selecting the VIN for assignment to the assembly schedule.
